(19) United States
(12) Patent Application Publication
(10) Pub. No.: US 2024/0353539 A1
(43) Pub. Date: Oct. 24, 2024

(54) DEVICE AND METHOD FOR GENERATING A FREQUENCY DISTRIBUTION BASED ON A SIGNAL

(71) Applicant: CANON KABUSHIKI KAISHA, Tokyo (JP)

(72) Inventor: DAISUKE KUROKI, Kanagawa (JP)

(21) Appl. No.: 18/633,366

(22) Filed: Apr. 11, 2024

(30) Foreign Application Priority Data
Apr. 21, 2023 (JP) 2023-070201

(51) Int. Cl. G01S 7/4865; G01S 17/14; G01S 17/93

(52) U.S. Cl. CPC G01S 7/4865; G01S 17/14; G01S 17/93

(57) ABSTRACT

A device including: a first generation unit generating first and second timings that are periodically repeated, and supplying the first and second timings to an emitting device as information indicating light emission timing; a receiving unit generating a signal based on incident light incident in an exposure period; a control unit performing control to shift the exposure period with reference to the first timing; and a second generation unit generating a frequency distribution indicating a relationship between time information from light emission to light reception and a frequency of light reception based on a signal generated in the receiving unit and information indicating a shift amount in the exposure period. A length of a shift range of the exposure period is shorter than a length of a period corresponding to a range.

### BACKGROUND

### Technical Field

The aspect of the embodiments relates to a ranging device and a ranging method.

### Description of the Related Art

U.S. Patent Application Publication No. 2017/0052065 discloses a ranging device that measures a distance to an object by emitting light from a light source and receiving light including reflected light from the object by a light receiving element. U.S. Patent Application Publication No. 2017/0052065 discloses a method of repeatedly performing measurement while changing a gating period in which detection of photons is performed in the light receiving element.

In a ranging method as disclosed in U.S. Patent Application Publication No. 2017/0052065, it is necessary to repeatedly perform light emission and light reception while changing the gating period, and thus time required for one ranging may be long. Therefore, in the ranging method, it may be difficult to improve a frame rate.

### SUMMARY

According to an aspect of the embodiments, there is provided a device including: a first generation unit configured to generate a first timing that is periodically repeated and a second timing that is periodically repeated, and configured to supply the first timing and the second timing to an emitting device as information indicating light emission timing; a receiving unit configured to generate a signal based on incident light incident in an exposure period; a control unit configured to perform control to shift the exposure period with reference to the first timing; and a second generation unit configured to generate a frequency distribution indicating a relationship between time information from light emission of the emitting device to light reception in the receiving unit and a frequency of light reception in the receiving unit based on a signal generated in the receiving unit and information indicating a shift amount in the exposure period. A length of a shift range of the exposure period is shorter than a length of a period corresponding to a range.

According to an aspect of the embodiments, there is provided a method including: generating a first timing that is periodically repeated and a second timing that is periodically repeated; supplying the first timing and the second timing to an emitting device as information indicating light emission timing; generating a signal based on incident light incident in an exposure period while shifting the exposure period with reference to the first timing; and generating a frequency distribution indicating a relationship between time information from light emission of the emitting device to light reception of the incident light and a frequency of light reception based on the generated signal and information indicating a shift amount in the exposure period. A length of a shift range of the exposure period is shorter than a length of a period corresponding to a range.

Further features of the disclosure will become apparent from the following description of exemplary embodiments with reference to the attached drawings.

### BRIEF DESCRIPTION OF THE DRAWINGS

FIG. 1 is a hardware block diagram illustrating a schematic configuration example of a ranging device according to a first embodiment.

FIG. 2 is a schematic diagram illustrating an overall configuration of a photoelectric conversion device according to the first embodiment.

FIG. 3 is a schematic block diagram illustrating a configuration example of a sensor substrate according to the first embodiment.

FIG. 4 is a schematic block diagram illustrating a configuration example of a circuit substrate according to the first embodiment.

FIG. 5 is a schematic block diagram illustrating a configuration example of one pixel of a photoelectric conversion unit and a pixel signal processing unit according to the first embodiment.

FIGS. 6A, 6B, and 6C are diagrams for explaining an operation of an avalanche photodiode according to the first embodiment.

FIG. 7 is a functional block diagram illustrating a schematic configuration example of the ranging device according to the first embodiment.

FIG. 8 is a schematic diagram for explaining a ranging frame, a sub-frame, and a micro-frame according to the first embodiment.

FIGS. 9A and 9B are timing charts illustrating a ranging method according to a comparative example.

FIG. 10 is a histogram illustrating a frequency distribution acquired by the ranging method according to the comparative example.

FIGS. 11A and 11B are timing charts illustrating a ranging method according to the first embodiment.

FIG. 12 is a histogram illustrating a frequency distribution acquired by the ranging method according to the first embodiment.

FIGS. 13A and 13B are timing charts illustrating the ranging method according to the first embodiment.

FIG. 14 is a histogram illustrating a frequency distribution acquired by the ranging method according to the first embodiment.

FIG. 15 is a histogram illustrating a frequency distribution generated by a frequency distribution generation unit according to the first embodiment.

FIG. 16 is a flowchart illustrating frequency distribution generation processing in the frequency distribution generation unit according to the first embodiment.

FIG. 17 is a timing chart illustrating a ranging method according to a second embodiment.

FIG. 18 is a timing chart illustrating a ranging method according to a third embodiment.

FIGS. 19A and 19B are schematic diagrams of equipment according to a fourth embodiment.

### DESCRIPTION OF THE EMBODIMENTS

Hereinafter, embodiments of the present disclosure will be described with reference to the drawings. Identical or corresponding elements are denoted by common reference numerals throughout the drawings, and the description thereof may be omitted or simplified.

### First Embodiment

FIG. 1 is a hardware block diagram illustrating a schematic configuration example of a ranging device 1 according to the present embodiment. The ranging device 1 includes a light emitting device 2, a signal processing circuit 3, and a light receiving device 4. Note that the configuration of the ranging device 1 illustrated in the present embodiment is an example, and is not limited to the illustrated configuration.

The ranging device 1 is a device that measures a distance to a ranging object X using a technology such as light detection and ranging (LiDAR). The ranging device 1 measures the distance from the ranging device 1 to the object X based on a time difference until the light emitted from the light emitting device 2 is reflected by the object X and received by the light receiving device 4. In addition, the ranging device 1 can two-dimensionally measure distances at a plurality of points by emitting laser light to a predetermined ranging range including the object X and receiving reflected light by the pixel array. As a result, the ranging device 1 can generate and output the distance image.

The light received by the light receiving device 4 includes ambient light such as sunlight in addition to the reflected light from the object X. Therefore, the ranging device 1 measures the light incident in each of a plurality of periods (bin periods) to generate a frequency distribution, and performs the ranging in which the influence of the ambient light is reduced using a method of determining that the reflected light is incident in the period in which a light amount is at the peak.

The light emitting device 2 is a device that emits light such as laser light to the outside of the ranging device 1. The signal processing circuit 3 may include a processor that performs arithmetic processing of the digital signal, a memory that stores the digital signal, and the like. The signal processing circuit 3 can be, for example, an integrated circuit such as a field-programmable gate array (FPGA) or an image signal processor (ISP).

The light receiving device 4 generates a pulse signal including a pulse based on the incident light. The light receiving device 4 is, for example, a photoelectric conversion device including an avalanche photodiode as a photoelectric conversion element. In this case, when one photon is incident on the avalanche photodiode to generate a charge, one pulse is generated by avalanche multiplication. However, the light receiving device 4 may use, for example, a photoelectric conversion element using another photodiode.

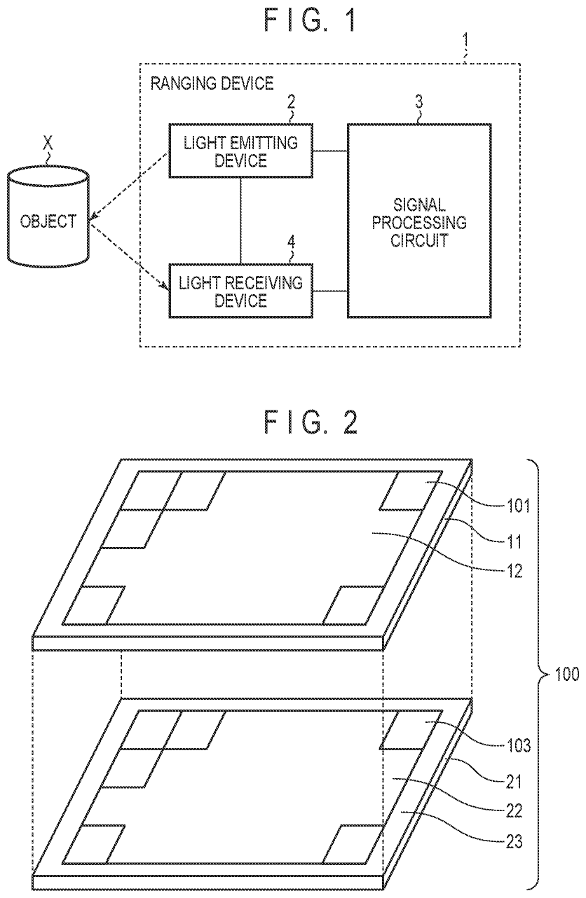

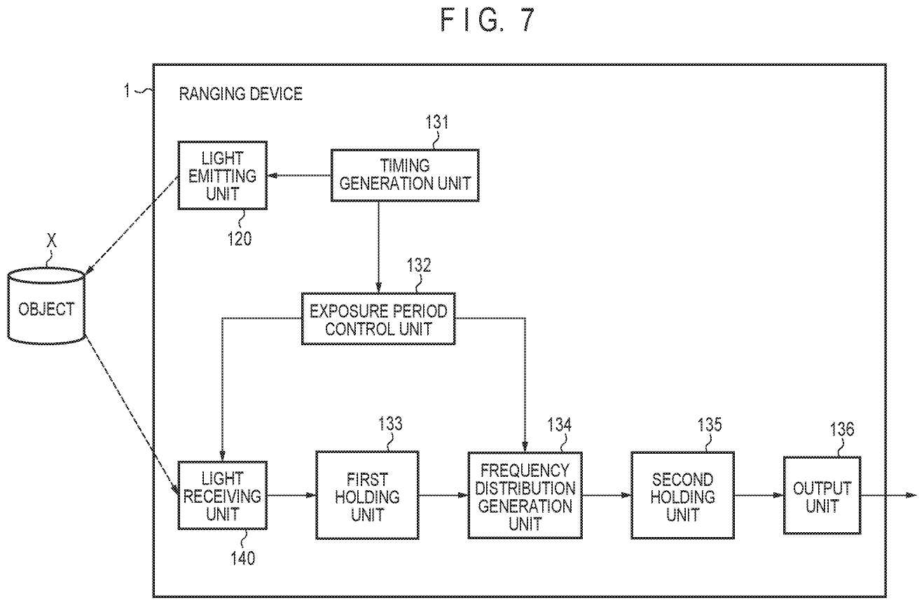

In the present embodiment, the light receiving device 4 includes a pixel array in which a plurality of photoelectric conversion elements (pixels) is arranged so as to form a plurality of rows and a plurality of columns. Here, a photoelectric conversion device as a specific configuration example of the light receiving device 4 will be described with reference to FIGS. 2 to 6C. A configuration example of the photoelectric conversion device described below is an example. The photoelectric conversion device applicable to the light receiving device 4 is not limited to this, and any photoelectric conversion device may be used as long as the function of FIG. 7 described later can be realized.

FIG. 2 is a schematic diagram illustrating an overall configuration of the photoelectric conversion device 100 according to the present embodiment. The photoelectric conversion device 100 includes a sensor substrate 11 (first substrate) and a circuit substrate 21 (second substrate) stacked on each other. The sensor substrate 11 and the circuit substrate 21 are electrically connected to each other. The sensor substrate 11 has a pixel region 12 in which a plurality of pixels 101 arranged to form a plurality of rows and a plurality of columns are arranged. The circuit substrate 21 includes a first circuit region 22 in which a plurality of pixel signal processing units 103 arranged to form a plurality of rows and a plurality of columns are arranged, and a second circuit region 23 arranged on an outer periphery of the first circuit region 22. The second circuit region 23 may include a circuit or the like that controls the plurality of pixel signal processing units 103. The sensor substrate 11 has a light incident surface that receives incident light and a connection surface facing the light incident surface. The sensor substrate 11 is connected to the circuit substrate 21 on the connection surface side. That is, the photoelectric conversion device 100 is a so-called back-illuminated type.

In the present specification, “plan view” refers to viewing from a direction perpendicular to a surface opposite to the light incident surface. In addition, the cross section refers to a surface in a direction perpendicular to a surface of the sensor substrate 11 on a side opposite to the light incident surface. Note that the light incident surface may be a rough surface in a microscopic view, but in this case, a plan view is defined with reference to the light incident surface in a macroscopic view.

Hereinafter, the sensor substrate 11 and the circuit substrate 21 will be described as diced chips, but the sensor substrate 11 and the circuit substrate 21 are not limited to chips. For example, the sensor substrate 11 and the circuit substrate 21 may be wafers. Furthermore, in a case where the sensor substrate 11 and the circuit substrate 21 are diced chips, the photoelectric conversion device 100 may be manufactured by stacking the chips in a wafer state and then dicing the chips, or may be manufactured by dicing and then stacking the chips.

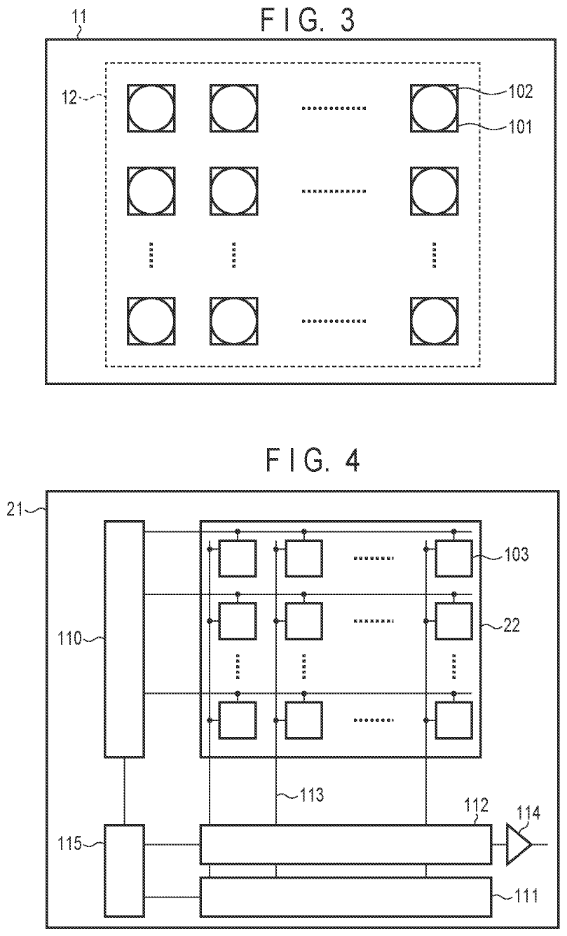

FIG. 3 is a schematic block diagram illustrating an arrangement example of the sensor substrate 11. In the pixel region 12, a plurality of pixels 101 arranged to form a plurality of rows and a plurality of columns is arranged. Each of the plurality of pixels 101 includes a photoelectric conversion unit 102 including an avalanche photodiode (hereinafter, referred to as APD) as a photoelectric conversion element in a substrate.

A conductivity type of a charge used as a signal charge among charge pairs generated in the APD is referred to as a first conductivity type. The first conductivity type refers to a conductivity type in which a charge having the same polarity as the signal charge is a majority carrier. In addition, a conductivity type opposite to the first conductivity type, that is, a conductivity type in which majority carriers are charges having a polarity different from that of the signal charges is referred to as a second conductivity type. In the APD described below, the anode of the APD has a fixed potential, and a signal is extracted from the cathode of the APD. Therefore, the semiconductor region of the first conductivity type is an N-type semiconductor region, and the semiconductor region of the second conductivity type is a P-type semiconductor region. Note that the cathode of the APD may have a fixed potential, and a signal may be extracted from the anode of the APD. In this case, the semiconductor region of the first conductivity type is a P-type semiconductor region, and the semiconductor region of the second conductivity type is an N-type semiconductor region. In addition, a case where one node of the APD is set to a fixed potential will be described below, but the potentials of both nodes may vary.

FIG. 4 is a schematic block diagram illustrating a configuration example of the circuit substrate 21. The circuit substrate 21 includes the first circuit region 22 in which the plurality of pixel signal processing units 103 arranged to form a plurality of rows and a plurality of columns are arranged.

In addition, a vertical scanning circuit 110, a horizontal scanning circuit 111, a reading circuit 112, a pixel output signal line 113, an output circuit 114, and a control signal generation unit 115 are arranged in the circuit substrate 21. The plurality of photoelectric conversion units 102 illustrated in FIG. 3 and the plurality of pixel signal processing units 103 illustrated in FIG. 4 are electrically connected via connection wires provided for the respective pixels 101.

The control signal generation unit 115 is a control circuit that generates a control signal for driving the vertical scanning circuit 110, the horizontal scanning circuit 111, and the reading circuit 112 and supplies the control signal to these units. As a result, the control signal generation unit 115 controls drive timing and the like of each unit.

The vertical scanning circuit 110 supplies a control signal to each of the plurality of pixel signal processing units 103 based on the control signal supplied from the control signal generation unit 115. The vertical scanning circuit 110 supplies the control signal for each row to each pixel signal processing unit 103 via a drive line provided for each row of the first circuit region 22. As will be described later, a plurality of the drive lines may be provided for each row. As the vertical scanning circuit 110, a logic circuit such as a shift register or an address decoder can be used. As a result, the vertical scanning circuit 110 selects a row to which a signal is output from the pixel signal processing unit 103.

The signal output from the photoelectric conversion unit 102 of the pixel 101 is processed by the pixel signal processing unit 103. The pixel signal processing unit 103 acquires and holds a digital signal by counting the number of pulses output from the APD included in the photoelectric conversion unit 102.

One pixel signal processing unit 103 may not be necessarily provided for every pixel 101. For example, one pixel signal processing unit 103 may be shared by a plurality of pixels 101. In this case, the pixel signal processing unit 103 sequentially processes the signal output from each photoelectric conversion unit 102, thereby providing a signal processing function to each pixel 101.

The horizontal scanning circuit 111 supplies a control signal to the reading circuit 112 based on the control signal supplied from the control signal generation unit 115. The pixel signal processing unit 103 is connected to the reading circuit 112 via the pixel output signal line 113 provided for each column of the first circuit region 22. The pixel output signal line 113 of one column is shared by the plurality of pixel signal processing units 103 of the corresponding column. The pixel output signal line 113 includes a plurality of wires and has at least a function of outputting a digital signal from each pixel signal processing unit 103 to the reading circuit 112 and a function of supplying a control signal for selecting a column from which a signal is to be output to the pixel signal processing unit 103. The reading circuit 112 outputs a signal to a storage unit or a signal processing unit outside the photoelectric conversion device 100 via the output circuit 114 based on the control signal supplied from the control signal generation unit 115.

The arrangement of the photoelectric conversion units 102 in the pixel region 12 may be one-dimensional. Furthermore, the function of the pixel signal processing unit 103 is not necessarily provided for every pixel 101. For example, one pixel signal processing unit 103 may be shared by a plurality of pixels 101. In this case, the pixel signal processing unit 103 sequentially processes the signal output from each photoelectric conversion unit 102, thereby providing a signal processing function to each pixel 101.

As illustrated in FIGS. 3 and 4, the first circuit region 22 in which the plurality of pixel signal processing units 103 is arranged is arranged in a region overlapping the pixel region 12 in plan view. Then, the vertical scanning circuit 110, the horizontal scanning circuit 111, the reading circuit 112, the output circuit 114, and the control signal generation unit 115 are arranged so as to overlap between the end of the sensor substrate 11 and the end of the pixel region 12 in plan view. In other words, the sensor substrate 11 has a pixel region 12 and a non-pixel region arranged around the pixel region 12. In the circuit substrate 21, the second circuit region 23 (described above in FIG. 2) in which the vertical scanning circuit 110, the horizontal scanning circuit 111, the reading circuit 112, the output circuit 114, and the control signal generation unit 115 are arranged is arranged in a region overlapping the non-pixel region in plan view.

Note that the arrangement of the pixel output signal lines 113, the arrangement of the reading circuits 112, and the arrangement of the output circuits 114 are not limited to those illustrated in FIG. 4. For example, the pixel output signal lines 113 may be arranged to extend in the row direction and may be arranged to be shared by the plurality of pixel signal processing units 103 of the corresponding row. Then, the reading circuit 112 may be arranged such that the pixel output signal lines 113 of each row are connected.

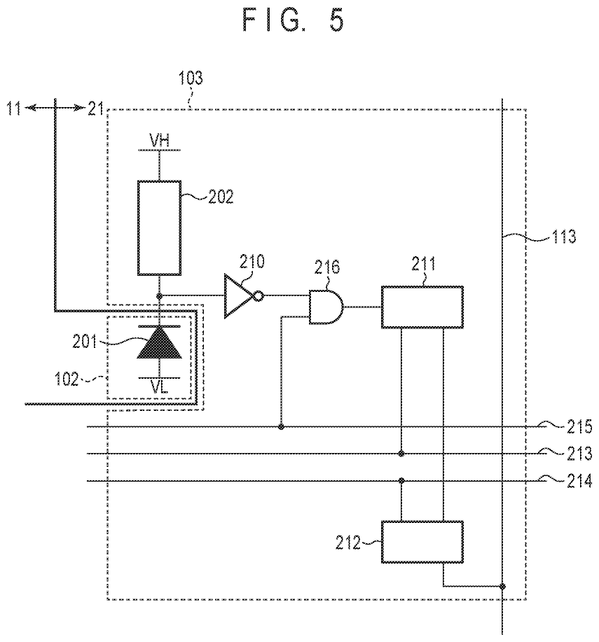

FIG. 5 is a schematic block diagram illustrating a configuration example of one pixel of the photoelectric conversion unit 102 and the pixel signal processing unit 103 according to the present embodiment. FIG. 5 schematically illustrates a more specific configuration example including a connection relationship between the photoelectric conversion unit 102 disposed on the sensor substrate 11 and the pixel signal processing unit 103 disposed on the circuit substrate 21. Note that, in FIG. 5, drive lines between the vertical scanning circuit 110 and the pixel signal processing unit 103 in FIG. 4 are illustrated as drive lines 213, 214, and 215.

The photoelectric conversion unit 102 includes an APD 201. The pixel signal processing unit 103 includes a quenching element 202, a waveform shaping unit 210, a counter circuit 211, a selection circuit 212, and a gating circuit 216. Note that, in one embodiment, the pixel signal processing unit 103 includes at least one of the waveform shaping unit 210, the counter circuit 211, the selection circuit 212, and the gating circuit 216.

The APD 201 generates a charge according to incident light by photoelectric conversion. A voltage VL (first voltage) is supplied to the anode of the APD 201. The cathode of the APD 201 is connected to the first terminal of the quenching element 202 and the input terminal of the waveform shaping unit 210. A voltage VH (second voltage) higher than the voltage VL supplied to the anode is supplied to the cathode of the APD 201. As a result, a reverse bias voltage that causes the APD 201 to perform an avalanche multiplication operation is supplied to the anode and the cathode of the APD 201. In the APD 201 to which the reverse bias voltage is supplied, when a charge is generated by incident light, the charge causes avalanche multiplication, and an avalanche current is generated.

The operation modes when the reverse bias voltage is supplied to the APD 201 include a Geiger mode and a linear mode. The Geiger mode is a mode in which the anode and the cathode are operated at a potential difference larger than a breakdown voltage, and the linear mode is a mode in which the anode and the cathode are operated at a potential difference close to or less than the breakdown voltage.

The APD operated in the Geiger mode is referred to as a single photon avalanche diode (SPAD). At this time, for example, the voltage VL (first voltage) is −30 V, and the voltage VH (second voltage) is 1 V. The APD 201 may be operated in the linear mode or the Geiger mode. In the case of the SPAD, the potential difference is larger than that of the APD in the linear mode, and the effect of avalanche multiplication becomes remarkable, so that the SPAD is used.

The quenching element 202 functions as a load circuit (quenching circuit) at the time of signal multiplication by avalanche multiplication. The quenching element 202 suppresses a voltage supplied to the APD 201 to suppress avalanche multiplication (quenching operation). In addition, the quenching element 202 returns the voltage supplied to the APD 201 to the voltage VH by applying a current corresponding to the voltage drop due to the quench operation (recharge operation). The quenching element 202 may be, for example, a resistive element.

The waveform shaping unit 210 shapes the potential change of the cathode of the APD 201 obtained at the time of photon detection, and outputs a pulse signal. As the waveform shaping unit 210, for example, an inverter circuit is used. Although FIG. 5 illustrates an example in which one inverter is used as the waveform shaping unit 210, the waveform shaping unit 210 may use a circuit in which a plurality of inverters are connected in series, or may be another circuit having a waveform shaping effect.

The gating circuit 216 is a circuit that performs gating so as to pass the pulse signal output from the waveform shaping unit 210 for a predetermined period. During a period during which the pulse signal can pass through the gating circuit 216, photons incident on the APD 201 are counted by the counter circuit 211 at the subsequent stage. Therefore, the gating circuit 216 controls an exposure period in which signal generation based on incident light is performed in the pixel 101. A period during which the pulse signal is allowed to pass is controlled by a control signal supplied from the vertical scanning circuit 110 via the drive line 215. FIG. 5 illustrates an example in which one AND circuit is used as the gating circuit 216. A pulse signal and a control signal are input to two input terminals of the AND circuit. The AND circuit outputs the logical product to the counter circuit 211. Note that the gating circuit 216 is used to realize gating, and may have a circuit configuration other than the AND circuit. In addition, the waveform shaping unit 210 and the gating circuit 216 may be integrated by using a logic circuit such as a NAND circuit.

The counter circuit 211 counts the pulse signal output from the waveform shaping unit 210 via the gating circuit 216 and holds a digital signal indicating a count value. Furthermore, when a control signal is supplied from the vertical scanning circuit 110 via the drive line 213, the counter circuit 211 resets the held signal. The counter circuit 211 can be, for example, a 1-bit counter.

The selection circuit 212 is supplied with a control signal from the vertical scanning circuit 110 illustrated in FIG. 4 via the drive line 214 illustrated in FIG. 5. In response to this control signal, the selection circuit 212 switches between electrical connection and disconnection between the counter circuit 211 and the pixel output signal line 113. The selection circuit 212 includes, for example, a buffer circuit or the like for outputting a signal corresponding to a value held in the counter circuit 211.

Note that, in the example of FIG. 5, switching between electrical connection and disconnection between the counter circuit 211 and the pixel output signal line 113 is performed in the selection circuit 212, but the method of controlling the signal output to the pixel output signal line 113 is not limited thereto. For example, a switch such as a transistor may be disposed at a node between the quenching element 202 and the APD 201, between the photoelectric conversion unit 102 and the pixel signal processing unit 103, or the like, and the signal output to the pixel output signal line 113 may be controlled by switching between electrical connection and non-connection. Furthermore, the signal output to the pixel output signal line 113 may be controlled by changing the value of the voltage VH or the voltage VL supplied to the photoelectric conversion unit 102 using a switch such as a transistor.

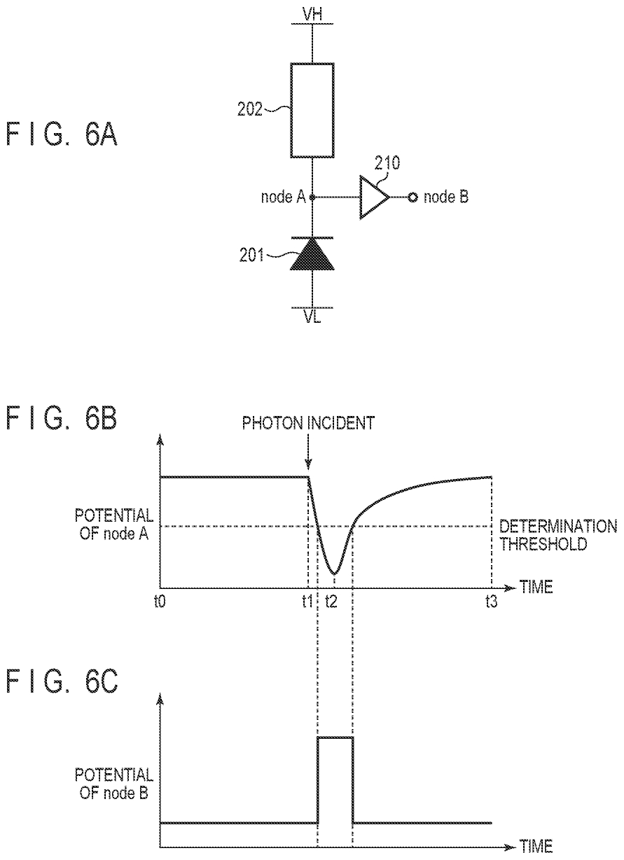

FIGS. 6A, 6B, and 6C are diagrams for explaining the operation of the APD 201 according to the present embodiment. FIG. 6A is an extracted view of the APD 201, the quenching element 202, and the waveform shaping unit 210 in FIG. 5. As illustrated in FIG. 6A, a connection node of the input terminals of the APD 201, the quenching element 202, and the waveform shaping unit 210 is node A. Furthermore, as illustrated in FIG. 6A, the output side of the waveform shaping unit 210 is node B.

FIG. 6B is a graph illustrating a temporal change of the potential of node A in FIG. 6A. FIG. 6C is a graph illustrating a temporal change of the potential of node B in FIG. 6A. In a period from time to t0 time t1, a voltage of VH-VL is applied to the APD 201 in FIG. 6A. When a photon is incident on the APD 201 at time t1, avalanche multiplication occurs in the APD 201. As a result, an avalanche current flows through the quenching element 202, and the potential of node A drops. Thereafter, a potential drop amount further increases, and the voltage applied to the APD 201 gradually decreases. Then, at time t2, the avalanche multiplication in the APD 201 stops. This causes the voltage level of node A to drop no more than a certain value. Thereafter, in a period from time t2 to time t3, a current compensating for the voltage drop flows from the node of the voltage VH in node A, and the node A settles to the original potential at time t3.

In the above-described process, the potential of node B goes to a high level in a period in which the potential of node A is lower than a certain threshold. In this way, the waveform of the potential drop of node A caused by the incidence of photon is shaped by the waveform shaping unit 210 and output as a pulse to node B.

Next, the overall configuration and operation of the ranging device 1 will be described in more detail. FIG. 7 is a functional block diagram illustrating a schematic configuration example of the ranging device 1 according to the present embodiment. The ranging device 1 includes a light emitting unit 120, a light receiving unit 140, a timing generation unit 131, an exposure period control unit 132, a first holding unit 133, a frequency distribution generation unit 134, a second holding unit 135, and an output unit 136.

The light emitting unit 120 corresponds to the light emitting device 2 in FIG. 1. The light receiving unit 140 corresponds to the light receiving device 4 in FIG. 1 or one pixel 101 in FIG. 4. The timing generation unit 131, the exposure period control unit 132, the first holding unit 133, the frequency distribution generation unit 134, the second holding unit 135, and the output unit 136 correspond to the signal processing circuit 3 in FIG. 1.

The timing generation unit 131 generates the first timing that is periodically repeated. A period between a certain first timing and the next first timing is referred to as a micro-frame period. Furthermore, the timing generation unit 131 generates the second timing that is different from the first timing and is periodically repeated. The second timing can be repeated with a cycle having the same length as the first timing. That is, one second timing exists in one micro-frame period.

The timing generation unit 131 supplies the generated first timing and second timing to the light emitting unit 120 and the exposure period control unit 132. The light emitting unit 120 emits pulsed light at light emission timings based on the first timing and the second timing. That is, the light emitting unit 120 emits pulsed light twice within one micro-frame period. A part of the emitted pulse light can be reflected by the object X and incident on the light receiving unit 140.

The exposure period control unit 132 determines the start timing of the exposure period in the light receiving unit 140 with reference to the first timing. The length of the exposure period can be set as appropriate. The length of the exposure period affects a ranging resolution in the ranging device 1. That is, when the exposure period is set to be short, a distance resolution increases, and when the exposure period is set to be long, the distance resolution decreases.

There is one exposure period in one micro-frame period. In addition, after a plurality of micro-frame periods in which exposure is performed at the same start timing ends, the exposure start timing is shifted by the length of the exposure period, and a plurality of micro-frame periods in which exposure is performed at the shifted start timing starts. In the present specification, a plurality of micro-frame periods in which exposure is performed at the same start timing is referred to as sub-frame periods. Therefore, the exposure period control unit 132 performs control to shift the exposure period every time the sub-frame period elapses. The shift amount of the exposure time is time information corresponding to the flight time of light from light emission to light reception, and is proportional to the distance from the ranging device 1 to the object X.

When light is incident during the exposure period, the light receiving unit 140 converts the received light into a pulse of an electric signal. The light receiving unit 140 can be configured as, for example, the photoelectric conversion device 100 described above. An output signal of the light receiving unit 140 is output to the first holding unit 133. The first holding unit 133 holds the plurality of signals input from the light receiving unit 140 as a first frequency distribution indicating a relationship between the shift amount in the exposure period and the frequency of reception of the incident light.

After a predetermined number of sub-frame periods have elapsed, the timing generation unit 131 changes the second timing to a timing different from the previous sub-frame period, and supplies the changed timing to the light emitting unit 120 and the exposure period control unit 132. When the second timing is changed, the exposure period control unit 132 returns the start timing of the exposure period to an initial value and controls the exposure period. Thereafter, the light receiving unit 140 and the exposure period control unit 132 similarly start signal acquisition in the next sub-frame period. After the second timing is changed, the first holding unit 133 holds the plurality of signals input from the light receiving unit 140 as a second frequency distribution indicating the relationship between the shift amount in the exposure period and the frequency of reception of the incident light.

Furthermore, after a predetermined sub-frame period has elapsed, the timing generation unit 131 outputs a signal notifying the end of measurement for one frame period to the exposure period control unit 132. The exposure period control unit 132 outputs a signal instructing generation of the frequency distribution to the frequency distribution generation unit 134.

The frequency distribution generation unit 134 receives the signal instructing generation of the frequency distribution, and acquires the first frequency distribution and the second frequency distribution from first holding unit 133. The frequency distribution generation unit 134 generates a frequency distribution of the entire ranging range based on the first frequency distribution and the second frequency distribution, and outputs the frequency distribution to second holding unit 135. The frequency distribution of the entire ranging range is a frequency distribution indicating a relationship between the shift amount in the exposure period corresponding to the entire ranging range and the frequency of reception of the incident light. Hereinafter, the frequency distribution of the entire ranging range may be referred to as a third frequency distribution.

The output unit 136 acquires the third frequency distribution from the second holding unit 135 every time one frame period elapses, and outputs the third frequency distribution to the outside of the ranging device 1. Alternatively, the output unit 136 may calculate the distance from the ranging device 1 to the object X from the peak information of the third frequency distribution, and output the distance information to the outside of the ranging device 1.

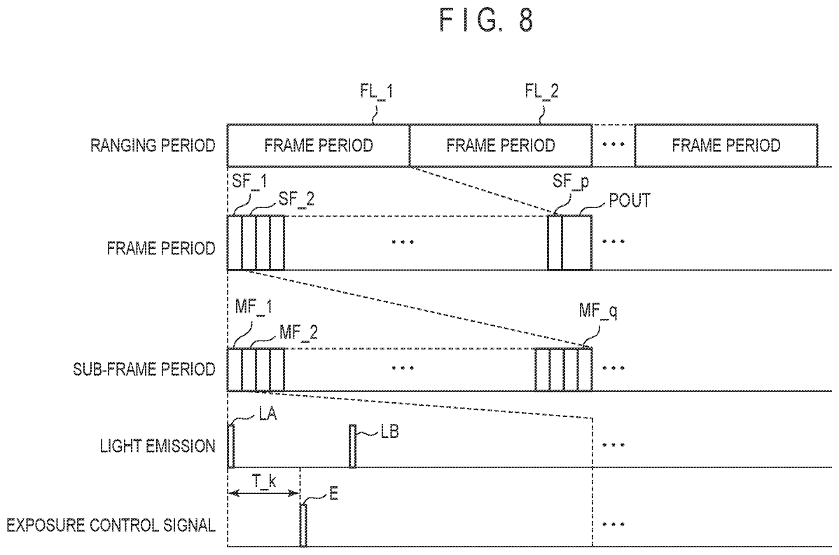

FIG. 8 is a schematic diagram for explaining a ranging frame, a sub-frame, and a micro-frame according to the present embodiment. A relationship among the above-described frame, sub-frame, and micro-frame will be described in more detail with reference to FIG. 8. FIG. 8 schematically illustrates acquisition periods of a ranging frame corresponding to one ranging result, a sub-frame used to generate the ranging frame, and a micro-frame used to generate the sub-frame by arranging blocks in a lateral direction. The lateral direction in FIG. 3 indicates the passage of time, and one block indicates an acquisition period of one ranging frame, sub-frame, or micro-frame. Furthermore, FIG. 8 illustrates a control signal for controlling a light emission period of the light emitting unit 120 and an exposure control signal for controlling an exposure period in the light receiving unit 140.

A “ranging period” in FIG. 8 indicates a plurality of frame periods FL_1, FL_2, . . . included in one ranging period. A frame period FL_1 indicates a first frame period in one ranging period, and a frame period FL_2 indicates a second frame period in one ranging period. The frame period is a period in which the ranging device 1 performs ranging once and outputs a signal indicating the distance (ranging result) from the ranging device 1 to the object X to the outside. Note that FIG. 8 illustrates an example of a case where determination and output of a peak are performed from frequency distribution in the ranging device 1, but this is not essential.

One ranging frame is generated from a plurality of sub-frames. A “frame period” in FIG. 8 illustrates a plurality of sub-frame periods SF_1, SF_2, . . . , and SF_p included in one frame period, and a peak output period POUT in which a peak is determined from frequency distribution and output. A sub-frame period SF_1 indicates a first sub-frame period in one frame period, and a sub-frame period SF_2 indicates a second sub-frame period in one frame period. In the present embodiment, the number of sub-frames is assumed to be p per frame (p is an integer of 2 or more). The sub-frame period SF_p indicates the p-th sub-frame period in one frame period.

One sub-frame is generated from a plurality of micro-frames. “Sub-frame period” in FIG. 8 illustrates a plurality of micro-frame periods MF_1, MF_2, . . . , and MF_q included in one sub-frame period. A micro-frame period MF_1 indicates a first micro-frame period in one sub-frame period, and a micro-frame period MF_2 indicates a second micro-frame period in one sub-frame period. In the present embodiment, it is assumed that the number of micro-frames is q per sub-frame (q is an integer of 2 or more). A micro-frame period MF_q indicates a q-th micro-frame period in one sub-frame period. The number q of micro-frames corresponds to the number of times of integration of light reception results.

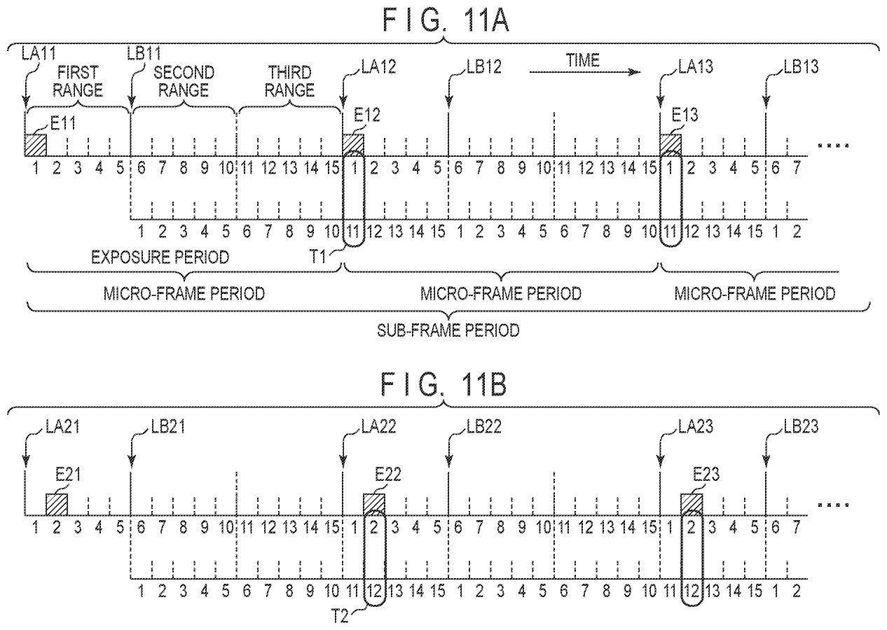

“Light emission” and “exposure control signal” in FIG. 8 indicate a light emission period of the light emitting unit 120 and an exposure control signal input to the light receiving unit 140 in one micro-frame period. The light emitting unit 120 emits light in a light emission period LA and a light emission period LB in which “light emission” is at a high level. A start time of the light emission period LA corresponds to the above-described first timing, and a start time of the light emission period LB corresponds to the above-described second timing. In addition, when light is incident on the light receiving unit 140 in the exposure period E in which the “exposure control signal” is at a high level, the incident light is detected in the light receiving unit 140. A period T_k from the start of the light emission period LA to the start of the exposure period E corresponds to a flight time of light from light emission to light reception in the light emission period LA. That is, the length of the period T_k corresponds to the ranging distance in the corresponding micro-frame. Note that k is a number of a corresponding sub-frame period and is an integer from 1 to p. Although not illustrated in FIG. 8, light emitted in the light emission period LB can also be received in the exposure period E. This will be described later in the description of FIGS. 11A and 11B and the like.

In each of the plurality of micro-frame periods MF_1, MF_2, . . . , and MF_q, the length of the period T_k from the start of the light emission period LA to the start of the exposure period E is the same. That is, in one sub-frame period, the light reception data is read (micro-frame acquisition) q times. When a photon is detected one or more times within one micro-frame period, the light receiving unit 140 outputs “1” as light reception data. By integrating q micro-frames acquired in one sub-frame period, data indicating the number of micro-frames in which a photon is detected is generated.

In each of the plurality of sub-frame periods SF_1, SF_2, . . . , and SF_p, the lengths of the periods T_1, T_2, . . . , and T_p are different from each other. As a result, in each of the plurality of sub-frame periods SF_1, SF_2, . . . , and SF_p, frequency distributions of light reception at different distances are acquired. In the peak output period POUT, the peak (maximum value) of the frequency distribution is detected from the frequency of each of the sub-frame periods SF_1, SF_2, . . . , and SF_p. The length of the period T_k corresponding to this peak is proportional to the distance from the ranging device 1 to the object X.

Hereinafter, more specific operations of the ranging device 1 of the present embodiment, such as the second timing, the method of determining the shift range of the exposure period, and the method of generating the third frequency distribution, will be described.

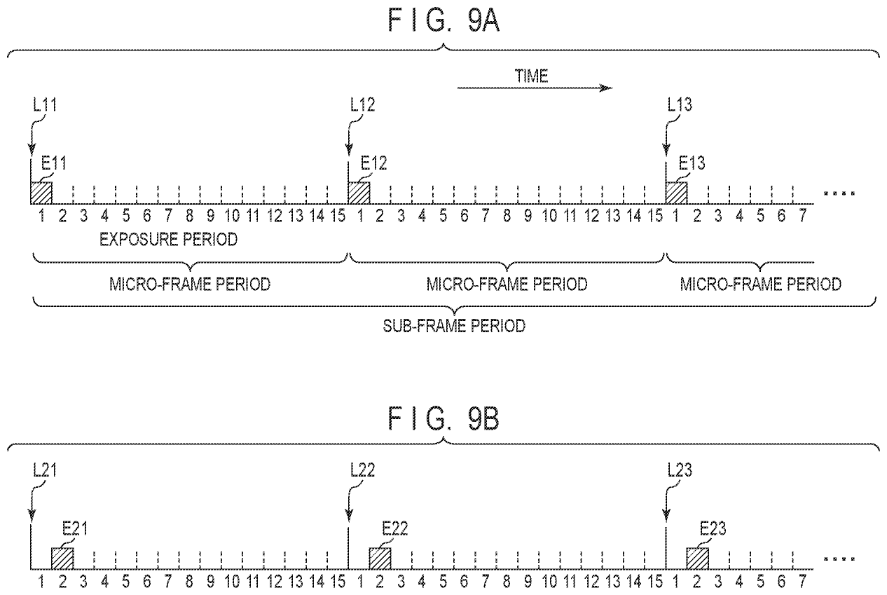

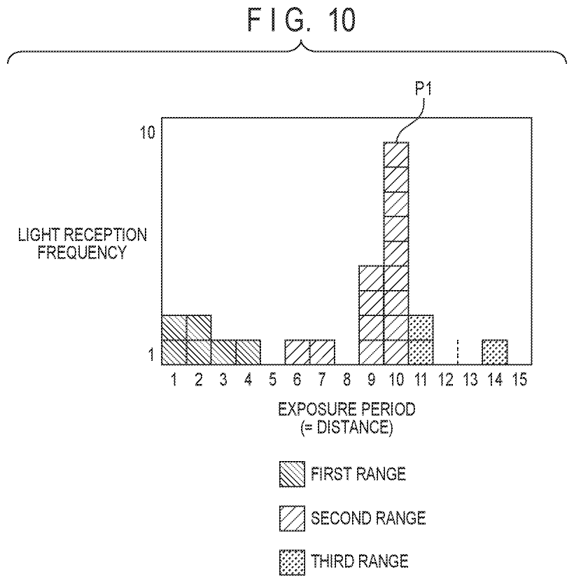

First, prior to the operation of the present embodiment, an operation method of a comparative example will be described with reference to FIGS. 9A, 9B, and 10. The present comparative example is an example in a case where there is no second timing in the present embodiment. In other words, the present comparative example is an example of a case where light emission is performed once in one micro-frame period.

FIGS. 9A and 9B are timing charts illustrating a ranging method according to a comparative example. Each of FIGS. 9A and 9B illustrates a relationship between a light emission timing and an exposure period with respect to a micro-frame period in one sub-frame period. One micro-frame period is divided into 15 periods (exposure periods) from “1” to “15”, and the exposure period is shifted such that one of these periods becomes the exposure period. Note that the number of divisions is an example, and the disclosure is not limited thereto.

In FIG. 9A, “L11”, “L12”, and “L13” indicate light emission timings, and “E11”, “E12”, and “E13” indicate exposure periods. As illustrated in FIG. 9A, the light emission timings L11, L12, and L13 (first timing) are repeated at a constant cycle, and correspond to the start time or the end time of the micro-frame period. Furthermore, in the example of FIG. 9A, the exposure periods E11, E12, and E13 are exposure periods “1” in the micro-frame period.

FIG. 9B illustrates the next sub-frame of FIG. 9A. In FIG. 9B, “L21”, “L22”, and “L23” indicate light emission timings, and “E21”, “E22”, and “E23” indicate exposure periods. As illustrated in FIG. 9B, the light emission timings L21, L22, and L23 are the same as those in FIG. 9A. Furthermore, in the example of FIG. 9B, the exposure periods E21, E22, and E23 are exposure periods “2” in the micro-frame period.

In FIGS. 9A and 9B, the illustration of the third and subsequent micro-frame periods is omitted, but the number of micro-frame periods in one sub-frame period is, for example, 10. Although FIGS. 9A and 9B illustrate two sub-frame periods in which “1” and “2” are exposure periods, thereafter, similar processing is performed while shifting the exposure period from “3” to “15”, and a total of 15 sub-frames are acquired. That is, since the number of sub-frames per frame is 15 and the number of micro-frames per sub-frame is 10, the number of micro-frames per frame is 150.

FIG. 10 is a histogram illustrating a frequency distribution acquired by the ranging method according to the comparative example. FIG. 10 illustrates an example of a frequency distribution indicating the relationship between the exposure period and the light reception frequency, which can be acquired in the example of the number of micro-frames described above, in the form of a histogram. Since 10 micro-frames are measured in one exposure period, a maximum value of a vertical axis of the histogram is 10.

In the example illustrated in FIG. 10, when the exposure period is “10”, the light reception frequency is the maximum value. That is, the peak P1 exists at the position of “10”. In this case, it is determined that the object X exists at a distance corresponding to “10”. In order to obtain the ranging result, light emission and light reception are required as many times as the number of micro-frames per frame (150 in the above example). A “first range”, a “second range”, and a “third range” illustrated in FIG. 10 will be described later.

Next, an operation method of the present embodiment will be described with reference to FIGS. 11A to 16. In the present embodiment, the second timing is added to the above-described comparative example. In other words, in the present embodiment, light emission is performed twice in one micro-frame period. In this description, parts common to the above-described comparative example may be omitted.

FIGS. 11A and 11B are timing charts illustrating the ranging method according to the present embodiment. Each of FIGS. 11A and 11B illustrates a relationship between two light emission timings and one exposure period with respect to a micro-frame period in one sub-frame period. One micro-frame period is divided into 15 periods from “1” to “15”.

One micro-frame period is divided into three equal intervals. That is, one micro-frame period is divided into a first range including “1” to “5”, a second range including “6” to “10”, and a third range including “11” to “15”. That is, the first range, the second range, and the third range do not overlap each other. The first range, the second range, and the third range have the same length. The shift of the exposure period in the present embodiment is performed not in the entire micro-frame period but only in the first range, that is, in the range of “1” to “5”.

As described above, the second timing is variable to one of the two types of timings. In FIGS. 11A and 11B, the second timing is the exposure period between “5” and “6”, that is, the start position of the second range.

In FIG. 11A, “LA11”, “LB11”, “LA12”, “LB12”, “LA13”, and “LB13” indicate light emission timings, and “E11”, “E12”, and “E13” indicate exposure periods. As illustrated in FIG. 11A, the light emission timings LA11, LA12, and LA13 (first timing) are repeated at a constant cycle, and correspond to the start time or the end time of the micro-frame period. Further, each of the light emission timings LB11, LB12, and LB13 (second timings) corresponds to a start position of the second range within the corresponding micro-frame period. Furthermore, in the example of FIG. 11A, the exposure periods E11, E12, and E13 are exposure periods “1” in the micro-frame period.

There are two light emission timings LA11 and LB11 within the first micro-frame period. Similarly, there are two light emission timings LA12 and LB12 within the second micro-frame period. Here, focusing on the period T1 in FIG. 11A corresponding to the exposure period of the second micro-frame, this period is the exposure period “1” based on the light emission timing LA12, and is also the exposure period “11” based on the light emission timing LB11. In this sub-frame, a signal obtained by adding the exposure period “1” based on the light emission timings LA11, LA12, and LA13 (first timing) and the exposure period “11” based on the light emission timings LB11, LB12, and LB13 (second timing) is acquired.

FIG. 11B illustrates the next sub-frame of FIG. 11A. In FIG. 11B, “LA21”, “LB21”, “LA22”, “LB22”, “LA23”, and “LB23” indicate light emission timings, and “E21”, “E22”, and “E23” indicate exposure periods. As illustrated in FIG. 11B, the light emission timings LA21, LA22, and LA23 (first timing) are repeated at a constant cycle, and correspond to the start time or the end time of the micro-frame period. Further, each of the light emission timings LB21, LB22, and LB23 (second timings) corresponds to a start position of the second range in the corresponding micro-frame. Furthermore, in the example of FIG. 11B, the exposure periods E21, E22, and E23 are exposure periods “2” in the micro-frame period.

There are two light emission timings LA21 and LB21 within the first micro-frame period. Similarly, there are two light emission timings LA22 and LB22 within the second micro-frame period. Here, focusing on the period T2 in FIG. 11B corresponding to the exposure period of the second micro-frame, this period is the exposure period “2” based on the light emission timing LA22, and is also the exposure period “12” based on the light emission timing LB21. In this sub-frame, a signal obtained by adding the exposure period “2” based on the light emission timings LA21, LA22, and LA23 (first timing) and the exposure period “12” based on the light emission timings LB21, LB22, and LB23 (second timing) is acquired.

FIGS. 11A and 11B illustrate two sub-frame periods in which “1” and “2” are exposure periods, but thereafter, similar processing is performed while shifting the exposure period from “3” to “5”. As a result, a total of five sub-frames are acquired for generating the first frequency distribution. That is, in the acquisition of the first frequency distribution, since the number of sub-frames per frame is 5 and the number of micro-frames per sub-frame is 10, the number of micro-frames per frame is 50.

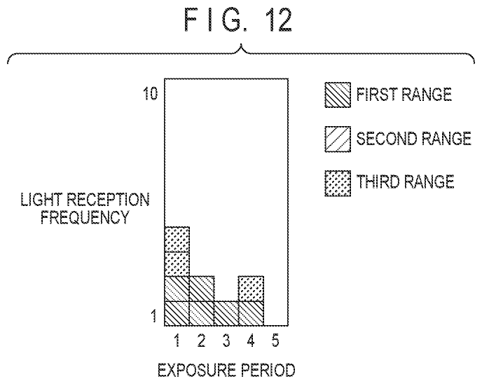

FIG. 12 is a histogram illustrating the first frequency distribution acquired by the ranging method according to the present embodiment. FIG. 12 illustrates an example of the first frequency distribution indicating the relationship between the exposure period and the light reception frequency, which can be acquired in the example of the number of micro-frames described above, in the form of a histogram. Since 10 micro-frames are measured in one exposure period, a maximum value of a vertical axis of the histogram is 10. Note that, in the examples of FIGS. 12, 14, and 15, the same incident light as in the example of FIG. 10 is incident.

As described above, in the exposure period “1” based on the light emission timing LA12, incident light corresponding to the exposure period “11” based on the light emission timing LB11 can also be detected in a superimposed manner. The same applies to other exposure periods. Therefore, information on the light reception frequencies in the exposure periods “11” to “15” (third range) is superimposed on the light reception frequencies acquired in the exposure periods “1” to “5” (first range). In this manner, the first frequency distribution in which the information of the first range and the information of the third range are superimposed is acquired.

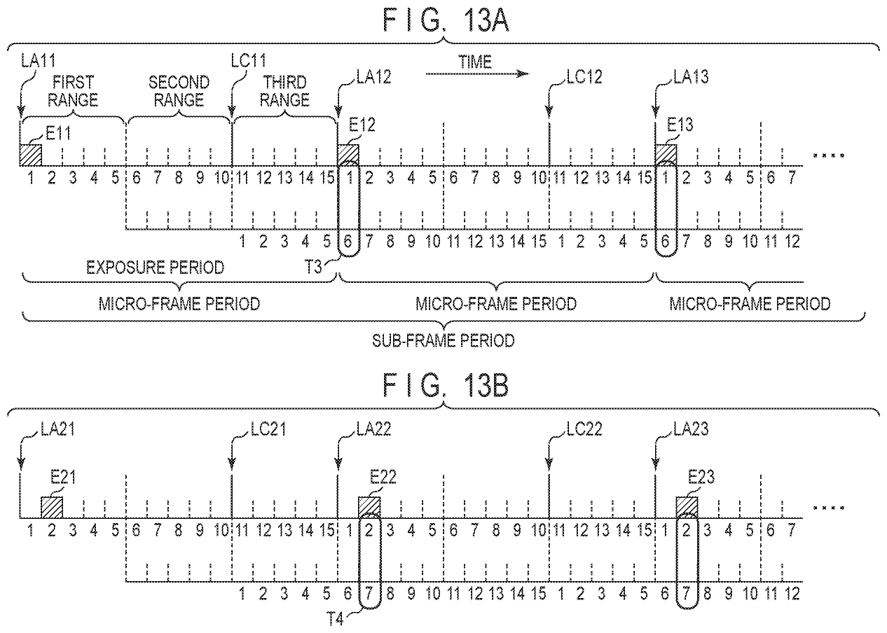

FIGS. 13A and 13B are timing charts illustrating the ranging method according to the present embodiment. In the ranging method of FIGS. 13A and 13B, the position of the second timing with respect to the first timing is different from that illustrated in FIGS. 11A and 11B. In FIGS. 13A and 13B, the second timing is the exposure period between “10” and “11”, that is, the start position of the third range. In FIGS. 13A and 13B, light emission timings LB11, LB12, and LB13 in FIGS. 11A and 11B are replaced with light emission timings LC11, LC12, and LC13, respectively. The other configurations are substantially the same as those in FIGS. 11A and 11B.

In FIG. 13A, there are two light emission timings LA11 and LC11 within the first micro-frame period. Similarly, there are two light emission timings LA12 and LC12 within the second micro-frame period. Here, focusing on the period T3 in FIG. 13A corresponding to the exposure period of the second micro-frame, this period is the exposure period “1” based on the light emission timing LA12, and is also the exposure period “6” based on the light emission timing LC11. In this sub-frame, a signal obtained by adding the exposure period “1” based on the light emission timings LA11, LA12, and LA13 (first timing) and the exposure period “6” based on the light emission timings LC11, LC12, and LC13 (second timing) is acquired.

FIG. 13B illustrates the next sub-frame of FIG. 13A. In FIG. 13B, there are two light emission timings LA21 and LC21 within the first micro-frame period. Similarly, there are two light emission timings LA22 and LC22 within the second micro-frame period. Here, focusing on the period T4 in FIG. 13B corresponding to the exposure period of the second micro-frame, this period is the exposure period “2” based on the light emission timing LA22, and is also the exposure period “7” based on the light emission timing LC21. In this sub-frame, a signal obtained by adding the exposure period “2” based on the light emission timings LA21, LA22, and LA23 (first timing) and the exposure period “7” based on the light emission timings LC21, LC22, and LC23 (second timing) is acquired.

FIGS. 13A and 13B illustrate two sub-frame periods in which “1” and “2” are exposure periods, but thereafter, similar processing is performed while shifting the exposure period from “3” to “5”. As a result, a total of five sub-frames are acquired for generating the second frequency distribution. That is, in the acquisition of the second frequency distribution, since the number of sub-frames per frame is 5 and the number of micro-frames per sub-frame is 10, the number of micro-frames per frame is 50.

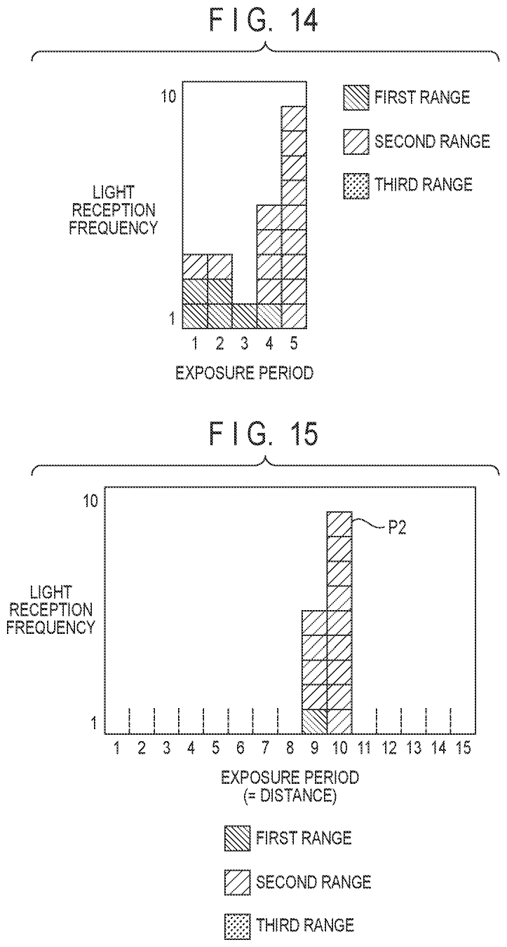

FIG. 14 is a histogram illustrating the second frequency distribution acquired by the ranging method according to the present embodiment. FIG. 14 illustrates an example of the second frequency distribution indicating the relationship between the exposure period and the light reception frequency, which can be acquired in the example of the number of micro-frames described above, in the form of a histogram. Since 10 micro-frames are measured in one exposure period, a maximum value of a vertical axis of the histogram is 10.

FIG. 15 is a histogram illustrating the third frequency distribution generated by the frequency distribution generation unit 134 according to the present embodiment. Based on the first frequency distribution and the second frequency distribution, frequency distribution generation unit 134 generates the third frequency distribution indicating the relationship between the exposure periods “1” to “15” and the light reception frequency. FIG. 15 illustrates an example of the third frequency distribution generated from the first frequency distribution in FIG. 12 and the second frequency distribution in FIG. 14. In the example illustrated in FIG. 15, in the exposure period “10”, the light reception frequency is the maximum value. That is, the peak P2 exists at the position of “10”. In this case, it is determined that the object X exists at a distance corresponding to “10”.

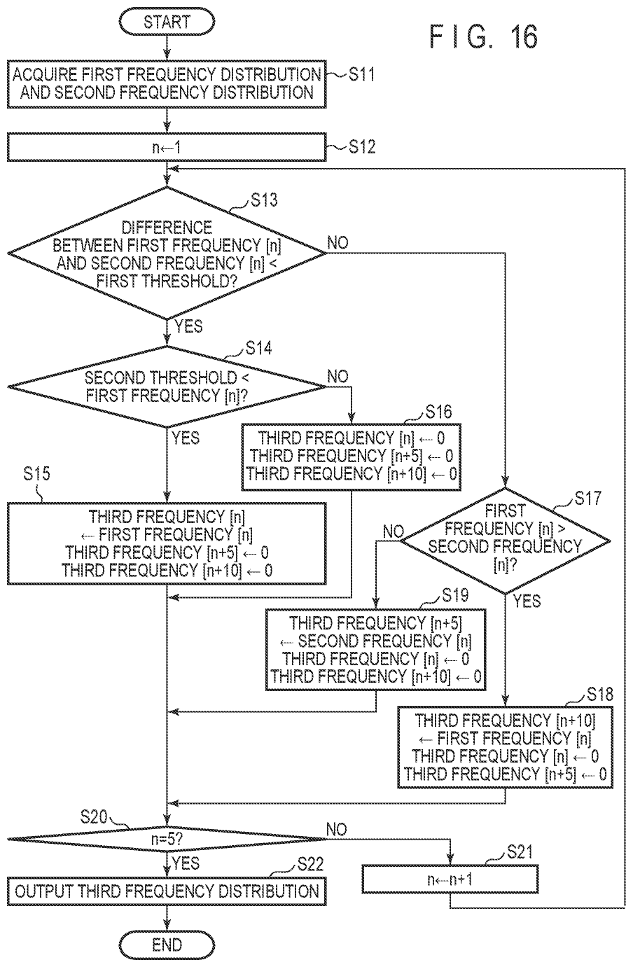

FIG. 16 is a flowchart illustrating the frequency distribution generation processing in the frequency distribution generation unit 134 according to the present embodiment. A method of generating the third frequency distribution will be described in more detail with reference to FIG. 16. Note that, in the processing of FIG. 16, it is assumed that acquisition of the first frequency distribution and the second frequency distribution for one ranging frame has been completed in advance, and the first holding unit 133 holds the first frequency distribution and the second frequency distribution. In the following description, the frequency corresponding to the exposure period “k” of the first frequency distribution is expressed as “first frequency [k]”. The same applies to the second frequency distribution and the third frequency distribution.

In Step S11, the frequency distribution generation unit 134 acquires the first frequency distribution and the second frequency distribution from the first holding unit 133. As described above, the first frequency distribution and the second frequency distribution are acquired in the range from the exposure period “1” to “5”. Therefore, in this processing, the frequency distribution generation unit 134 acquires the first frequency [5] from the first frequency [1] and the second frequency [5] from the second frequency [1].

In Step S12, the frequency distribution generation unit 134 initializes a loop counter variable n to 1. Note that n is an integer from 1 to 5. Furthermore, “←” in FIG. 16 is an assignment operator meaning processing of assigning the value of the right side to the variable of the left side.

In subsequent Steps S13, S14, and S17, determination based on the first frequency [n] and the second frequency [n] in the same section of the first frequency distribution and the second frequency distribution is performed. Then, in Steps S15, S16, S18, and S19, processing of determining the frequency of the third frequency distribution is performed based on the determination result and the values of the first frequency [n] and the second frequency [n].

In Step S13, the frequency distribution generation unit 134 determines whether a difference between the first frequency [n] and the second frequency [n] (an absolute value of (second frequency [n]−first frequency [n])) is smaller than a predetermined first threshold. When the difference is smaller than the first threshold (YES in Step S13), the processing proceeds to Step S14. In this case, the light reception frequency in the exposure period “n” is caused by the reflected light or the ambient light of the light emission at the first timing. When the difference is the first threshold or more (NO in Step S13), the processing proceeds to Step S17. In this case, the light reception frequency in the exposure period “n” is caused by the reflected light of the light emission at the second timing.

In Step S14, the frequency distribution generation unit 134 determines whether the first frequency [n] is larger than a predetermined second threshold. When the first frequency [n] is larger than the second threshold (YES in Step S14), the processing proceeds to Step S15. In this case, the light reception frequency in the exposure period “n” is caused by the reflected light of the light emission at the first timing. When the first frequency [n] is equal to or smaller than the second threshold (NO in Step S14), the processing proceeds to Step S16. In this case, the light reception frequency in the exposure period “n” is caused by the ambient light.

In Step S15, the frequency distribution generation unit 134 assigns the value of the first frequency [n] to the third frequency [n], and assigns 0 to the third frequency [n+5] and the third frequency [n+10]. Thereafter, the processing proceeds to Step S20. Since it is determined in the processing of Steps S13 and S14 that the light reception frequency in the exposure period “n” is caused by the reflected light of the light emission at the first timing, the value of the first frequency distribution is applied as the value of the third frequency distribution in Step S15.

In Step S16, the frequency distribution generation unit 134 assigns 0 to the third frequency [n], the third frequency [n+5], and the third frequency [n+10]. Thereafter, the processing proceeds to Step S20. Since it is determined in the processing of Steps S13 and S14 that the light reception frequency in the exposure period “n” is caused by the disturbance light, the values of the first frequency distribution and the second frequency distribution are not used in Step S16, and 0 is applied as the value of the third frequency distribution.

In Step S17, the frequency distribution generation unit 134 determines whether the first frequency [n] is larger than the second frequency [n]. When the first frequency [n] is larger than the second frequency [n] (YES in Step S17), the processing proceeds to Step S18. In this case, the light reception frequency in the exposure period “n” is caused by the reflected light of the light emission at the second timing in the acquisition of the first frequency distribution as illustrated in FIGS. 11A and 11B. When the first frequency [n] is equal to or smaller than the second threshold (NO in Step S17), the processing proceeds to Step S19. In this case, the light reception frequency in the exposure period “n” is caused by the reflected light of the light emission at the second timing in the acquisition of the second frequency distribution as illustrated in FIGS. 13A and 13B.

In Step S18, the frequency distribution generation unit 134 assigns the value of the first frequency [n] to the third frequency [n+10], and assigns 0 to the third frequency [n] and the third frequency [n+5]. Thereafter, the processing proceeds to Step S20. Since it is determined in the processing of Steps S13 and S17 that the light reception frequency in the exposure period “n” is caused by the reflected light of the light emission at the second timing in the acquisition of the first frequency distribution, the first frequency distribution is applied as the value of the third frequency distribution in Step S18. At this time, the exposure period to which the value is applied is shifted by the time difference between the first timing and the second timing.

In Step S19, the frequency distribution generation unit 134 assigns the value of the second frequency [n] to the third frequency [n+5], and assigns 0 to the third frequency [n] and the third frequency [n+10]. Thereafter, the processing proceeds to Step S20. Since it is determined in the processing of Steps S13 and S17 that the light reception frequency in the exposure period “n” is caused by the reflected light of the light emission at the second timing in the acquisition of the second frequency distribution, the second frequency distribution is applied as the value of the third frequency distribution in Step S19. At this time, the exposure period to which the value is applied is shifted by the time difference between the first timing and the second timing. As described above, in Steps S17 to S19, processing is performed such that the larger one of the first frequency [n] and the second frequency [n] is applied to the frequency of the third frequency distribution.

In Step S20, the frequency distribution generation unit 134 determines whether the value of the loop counter variable n is 5, that is, whether the processing corresponding to the number of shifts of the exposure period has been completed. When the value of the loop counter variable n is 5 (YES in Step S20), the processing proceeds to Step S22. When the value of the loop counter variable n is not 5 (NO in Step S20), the processing proceeds to Step S21.

In Step S21, the frequency distribution generation unit 134 increments (adds by 1) the value of the loop counter variable n. Thereafter, the processing proceeds to Step S13, and the similar process is repeated.

In Step S22, the frequency distribution generation unit 134 outputs the generated third frequency distribution to the second holding unit 135. The second holding unit 135 holds the generated third frequency distribution. As a result, the frequency distribution generation processing ends.

The first threshold value and the second threshold value described above are values set in advance in consideration of ranging conditions, environments, and the like. Examples of factors to be considered in the setting of the first threshold and the second threshold include the number of micro-frames per sub-frame, the amount of ambient light in the ranging environment, and the like.

By applying the processing of FIG. 16 to the first frequency distribution of FIG. 12 and the second frequency distribution of FIG. 14, the third frequency distribution of FIG. 15 is obtained. For example, when the exposure period “5” is taken as an example, the first frequency [5] is 0 from FIG. 12, and the second frequency [5] is 9 from FIG. 14. Since the difference between the first frequency [5] and the second frequency [5] is sufficiently large and the first frequency [5]>the second frequency [5], the processing of Step S19 is performed. That is, the value 9 of the second frequency [5] is assigned to the third frequency [10], and 0 is assigned to the third frequency [5] and the third frequency [15]. Therefore, as illustrated in FIG. 15, the peak P2 of the light reception frequency 9 is detected at the position “10”.

As described above, also in the method of the present embodiment, it is possible to generate a frequency distribution capable of detecting a peak similarly to the comparative example. When FIG. 10 and FIG. 15 are compared with each other, the similar peak of the light reception frequency is obtained for the peak at the position of “10” although the light reception frequency of the portion other than the peak is different, and the same distance can be calculated. Meanwhile, while the number of micro-frames required to generate the frequency distribution of FIG. 10 is 150, the number of micro-frames required to generate the frequency distribution of FIG. 10 is 100, and the number of micro-frames is reduced. As a result, the length of the ranging frame period can be shortened.

In the present embodiment, the length of the shift range of the exposure period in the acquisition of the first frequency distribution or the second frequency distribution is shorter than the length of one micro-frame period corresponding to the ranging range of the third frequency distribution. The sum of the shift range of the exposure period in the acquisition of the first frequency distribution and the shift range of the exposure period in the acquisition of the second frequency distribution is also shorter than the length of one micro-frame period. That is, by performing light emission a plurality of times in one micro-frame period, it is possible to acquire the frequency distribution of the entire ranging range by shifting the exposure period by an amount corresponding to a part of the ranging range. As a result, the length of the ranging frame period is shortened, and the frame rate can be improved. Therefore, according to the present embodiment, a ranging device and a ranging method capable of improving a frame rate are provided.

### Second Embodiment

In the present embodiment, a modification in which a period not subject to a ranging target is included in a micro-frame period will be described. In the present embodiment, the description of elements common to the first embodiment may be omitted or simplified.

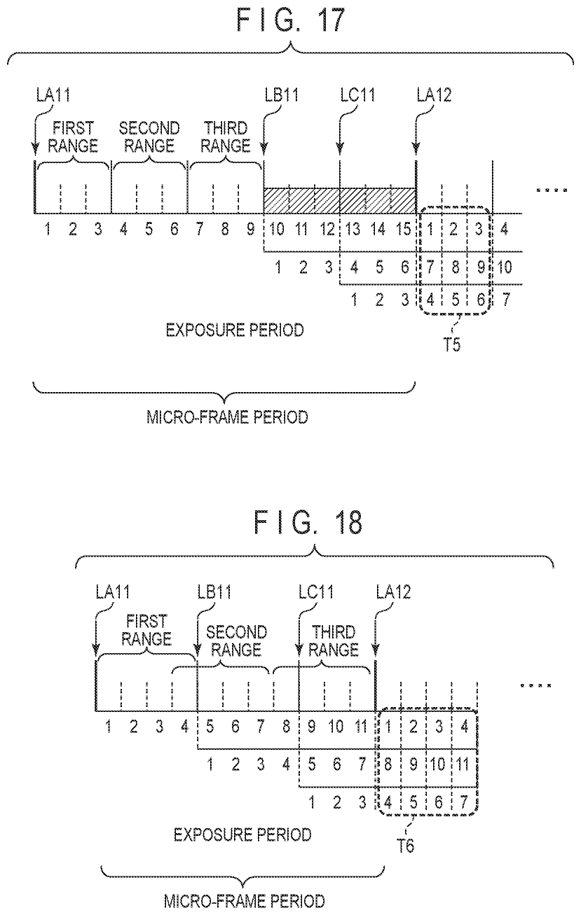

FIG. 17 is a timing chart illustrating the ranging method according to the present embodiment. FIG. 17 illustrates a relationship between a plurality of light emission timings and a ranging range in a micro-frame period. As in the first embodiment, one micro-frame period is divided into 15 periods from “1” to “15”. In FIG. 17, the light emission timings LA11 and LA12, which are the first timings, are repeated at a constant cycle, and correspond to the start time or the end time of the micro-frame period. The light emission timing LB11, which is the second timing, is located between the exposure periods “9” and “10” in the micro-frame period, and the light emission timing LC11, which is the second timing, is located between the exposure periods “12” and “13” in the micro-frame period. As in the first embodiment, the second timing is variable to one of the two types of timings. Although both the light emission timings LB11 and LC11 are illustrated in FIG. 17, either the light emission timing LB11 or the light emission timing LC11 is applied according to the sub-frame period.

In the first embodiment, all of “1” to “15” in the micro-frame period are ranging ranges. Meanwhile, in the present embodiment, in the micro-frame period, “1” to “9” are ranging ranges, and “10” to “15” (fourth range), which are periods (that is, the long distance) after these, are out of the ranging ranges. That is, the third frequency distribution includes frequency information corresponding to “1” to “9” and does not include frequency information corresponding to “10” to “15”. This method can be applied to an application in which a part of the distance range is excluded from the ranging range, such as a case where the ranging is performed at a short distance, a case where the ranging accuracy cannot be secured due to an influence of light attenuation or the like at a certain distance or more, and the like.

The ranging range in one micro-frame period is divided into three at equal intervals. That is, the ranging range in one micro-frame period is divided into a first range including “1” to “3”, a second range including “4” to “6”, and a third range including “7” to “9”. The shift of the exposure period in the present embodiment is performed not in the entire micro-frame period but only in the first range, that is, in the range of “1” to “3”.

Attention is paid to a period T5 in FIG. 17, that is, exposure periods “1” to “3” (first range) based on the light emission timing LA12. The exposure periods “7” to “9” (third range) based on the light emission timing LB11 are included in the period T5. In addition, the exposure periods “4” to “6” (second range) based on the light emission timing LC11 are also included in the period T5. By shifting the exposure period within the range of the exposure period from “1” to “3” based on the light emission timing LA12 to perform measurement, it is possible to acquire information of reflected light incident in the exposure period from “7” to “9” or the exposure period from “4” to “6”. Therefore, the first frequency distribution and the second frequency distribution can be acquired by the same method as that of the first embodiment, and the third frequency distribution can be acquired from the first frequency distribution and the second frequency distribution.

Therefore, according to the present embodiment, a ranging device and a ranging method capable of improving a frame rate are provided, as in the first embodiment, even in a case where a period other than the ranging target is included in a micro-frame period.

### Third Embodiment

In the present embodiment, a modification in a case where the micro-frame period is not evenly divided will be described. In the present embodiment, the description of elements common to the first embodiment may be omitted or simplified.

FIG. 18 is a timing chart illustrating the ranging method according to the present embodiment. FIG. 18 illustrates a relationship between a plurality of light emission timings and a ranging range in a micro-frame period. One micro-frame period is divided into 11 periods from “1” to “11”. In FIG. 17, the light emission timings LA11 and LA12, which are the first timings, are repeated at a constant cycle, and correspond to the start time or the end time of the micro-frame period. The light emission timing LB11, which is the second timing, is located between the exposure periods “4” and “5” in the micro-frame period, and the light emission timing LC11, which is the second timing, is located between the exposure periods “8” and “9” in the micro-frame period. As in the first embodiment, the second timing is variable to one of the two types of timings. Although both the light emission timings LB11 and LC11 are illustrated in FIG. 18, either the light emission timing LB11 or the light emission timing LC11 is applied according to the sub-frame period.

One micro-frame period is divided into three equal lengths. That is, one micro-frame period is divided into a first range including “1” to “4”, a second range including “4” to “7”, and a third range including “8” to “11”. The shift of the exposure period in the present embodiment is performed not in the entire micro-frame period but only in the first range, that is, in the range of “1” to “4”. As described above, in the present embodiment, the exposure period “4” overlaps between the first range and the second range.

Attention is paid to a period T6 in FIG. 18, that is, exposure periods “1” to “4” (first range) based on the light emission timing LA12. The exposure periods “8” to “11” (third range) based on the light emission timing LB11 are included in the period T5. In addition, the exposure periods “4” to “7” (second range) based on the light emission timing LC11 are also included in the period T5. By shifting the exposure period within the range of the exposure period from “1” to “4” based on the light emission timing LA12 to perform measurement, it is possible to acquire information of reflected light incident in the exposure period from “8” to “11” or the exposure period from “4” to “7”. Therefore, the first frequency distribution and the second frequency distribution can be acquired by the same method as that of the first embodiment, and the third frequency distribution can be acquired from the first frequency distribution and the second frequency distribution. In this method, although some exposure periods (in this example, the exposure period “4”) are overlapped and acquired in the first frequency distribution or the second frequency distribution, the third frequency distribution can be acquired similarly to the first embodiment.

Therefore, according to the present embodiment, a ranging device and a ranging method capable of improving a frame rate are provided similarly to the first embodiment even in a case where a micro-frame period is not equally divided.

### Fourth Embodiment

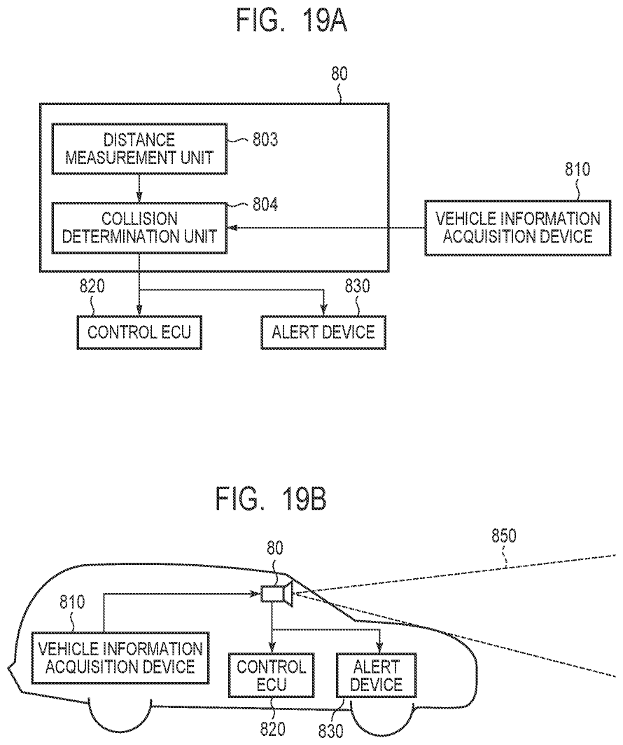

FIGS. 19A and 19B are block diagrams of equipment relating to an in-vehicle ranging device according to the present embodiment. Equipment 80 includes a distance measurement unit 803, which is an example of the ranging device 1 of the above-described embodiments, and a signal processing device (processing device) that processes a signal from the distance measurement unit 803. The equipment 80 includes the distance measurement unit 803 that measures a distance to an object, and a collision determination unit 804 that determines whether or not there is a possibility of collision based on the measured distance. The distance measurement unit 803 is an example of a distance information acquisition unit that obtains distance information to the object. That is, the distance information is information on a distance to the object or the like. The collision determination unit 804 may determine the collision possibility using the distance information.

The equipment 80 is connected to a vehicle information acquisition device 810, and can obtain vehicle information such as a vehicle speed, a yaw rate, and a steering angle. Further, the equipment 80 is connected to a control ECU 820 which is a control device that outputs a control signal for generating a braking force to the vehicle based on the determination result of the collision determination unit 804. The equipment 80 is also connected to an alert device 830 that issues an alert to the driver based on the determination result of the collision determination unit 804. For example, when the collision possibility is high as the determination result of the collision determination unit 804, the control ECU 820 performs vehicle control to avoid collision or reduce damage by braking, returning an accelerator, suppressing engine output, or the like. The alert device 830 alerts the user by sounding an alarm, displaying alert information on a screen of a car navigation system or the like, or giving vibration to a seat belt or a steering wheel. These devices of the equipment 80 function as a movable body control unit that controls the operation of controlling the vehicle as described above.

In the present embodiment, ranging is performed in an area around the vehicle, for example, a front area or a rear area, by the equipment 80. FIG. 19B illustrates equipment when ranging is performed in the front area of the vehicle (ranging area 850). The vehicle information acquisition device 810 as a ranging control unit sends an instruction to the equipment 80 or the distance measurement unit 803 to perform the ranging operation. With such a configuration, the accuracy of distance measurement can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### Modified Embodiments

The present disclosure is not limited to the above embodiments, and various modifications are possible. For example, an example in which some of the configurations of any one of the embodiments are added to other embodiments and an example in which some of the configurations of any one of the embodiments are replaced with some of the configurations of other embodiments are also embodiments of the present disclosure.

The disclosure of this specification includes a complementary set of the concepts described in this specification. That is, for example, if a description of “A is B” (A=B) is provided in this specification, this specification is intended to disclose or suggest that “A is not B” even if a description of “A is not B” (A≠B) is omitted. This is because it is assumed that “A is not B” is considered when “A is B” is described.

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, a ranging device and a ranging method capable of improving a frame rate are provided.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-070201, filed Apr. 21, 2023, which is hereby incorporated by reference herein in its entirety.

What is claimed is:

1. A device comprising:
a first generation unit configured to generate a first timing that is periodically repeated and a second timing that is periodically repeated, and configured to supply the first timing and the second timing to an emitting device as information indicating light emission timing;
a receiving unit configured to generate a signal based on incident light incident in an exposure period;
a control unit configured to perform control to shift the exposure period with reference to the first timing; and
a second generation unit configured to generate a frequency distribution indicating a relationship between time information from light emission of the emitting device to light reception in the receiving unit and a frequency of light reception in the receiving unit based on a signal generated in the receiving unit and information indicating a shift amount in the exposure period,
wherein a length of a shift range of the exposure period is shorter than a length of a period corresponding to a range.

2. The device according to claim 1,
wherein a period corresponding to the range includes a first range, a second range, and a third range, and
wherein the shift range of the exposure period corresponds to the first range.

3. The device according to claim 2, wherein a length of the first range, a length of the second range, and a length of the third range are equal to each other.

4. The device according to claim 2, wherein the first range, the second range, and the third range do not overlap each other.

5. The device according to claim 2, wherein two of the first range, the second range, and the third range partially overlap each other.

6. The device according to claim 2,
wherein a period corresponding to the range includes a fourth range that does not overlap any of the first range, the second range, and the third range, and
wherein the frequency distribution does not include frequency information corresponding to the fourth range.

7. The device according to claim 6, wherein in a period corresponding to the range, the fourth range is later than any of the first range, the second range, and the third range.

8. The device according to claim 2, wherein the shift range of the exposure period is set such that frequency information corresponding to the first range is acquired based on light emitted from the emitting device at the first timing, and frequency information corresponding to the second range or the third range is acquired based on light emitted from the emitting device at the second timing.

9. The device according to claim 2, wherein the second generation unit generates a first frequency distribution including frequency information corresponding to the first range and frequency information corresponding to the third range and a second frequency distribution including frequency information corresponding to the first range and frequency information corresponding to the second range.

10. The device according to claim 9, wherein the first generation unit switches a state in which the second generation unit generates the first frequency distribution and a state in which the second generation unit generates the second frequency distribution by switching a time difference between the first timing and the second timing.

11. The device according to claim 9, wherein the second generation unit generates a third frequency distribution based on the first frequency distribution and the second frequency distribution.

12. The device according to claim 11, wherein the second generation unit determines a frequency of the third frequency distribution based on values of a first frequency and a second frequency in the same section of the first frequency distribution and the second frequency distribution.

13. The device according to claim 12, wherein when a difference between the first frequency and the second frequency is greater than or equal to a first threshold, the second generation unit applies a larger one of the first frequency and the second frequency to the frequency of the third frequency distribution.

14. The device according to claim 12, wherein when a difference between the first frequency and the second frequency is less than a first threshold and the first frequency is greater than a second threshold, the second generation unit applies the first frequency to a frequency of the third frequency distribution.

15. The device according to claim 12, wherein when a difference between the first frequency and the second frequency is less than a first threshold and the first frequency is less than or equal to a second threshold, the second generation unit does not apply both the first frequency and the second frequency to a frequency of the third frequency distribution.

16. The device according to claim 11, wherein the third frequency distribution includes frequency information corresponding to the first range, frequency information corresponding to the second range, and frequency information corresponding to the third range.

17. The device according to claim 11, wherein a distance is calculated based on a shift amount corresponding to a peak of frequencies in the third frequency distribution.

18. Equipment comprising:
the device according to claim 1; and
a processing device configured to process distance information acquired by the device.

19. A movable body comprising:
the device according to claim 1; and
a movable body control unit configured to control the movable body based on distance information acquired by the device.

20. A method comprising:
generating a first timing that is periodically repeated and a second timing that is periodically repeated;
supplying the first timing and the second timing to an emitting device as information indicating light emission timing;
generating a signal based on incident light incident in an exposure period while shifting the exposure period with reference to the first timing; and
generating a frequency distribution indicating a relationship between time information from light emission of the emitting device to light reception of the incident light and a frequency of light reception based on the generated signal and information indicating a shift amount in the exposure period,
wherein a length of a shift range of the exposure period is shorter than a length of a period corresponding to a range.
